(19) United States
(12) Patent Application Publication
(10) Pub. No.: US 2005/0053795 A1
(43) Pub. Date: Mar. 10, 2005

(54) Dual seed layer for recording media

(75) Inventor: Yukiko Kubota, Pittsburgh, PA (US)

Correspondence Address: Benjamin T. Queen, II;Pietragallo Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 10/656,348

(22) Filed: Sep. 5, 2003

(51) Int. Cl. B32B 15/04; B32B 9/00

(52) U.S. Cl. 428/469; 428/472.2; 428/336; 428/694 T; 428/694 TS

(57) ABSTRACT

A recording medium comprises a recording layer and a dual layer seed layer. The dual layer seed layer includes a first layer including at least one of Cu, Au, Ag, Al or copper alloys and a second layer formed between the recording layer and first layer. The second layer comprises a metal oxide, such as ITO. A magnetic disc drive storage system and a thin film structure are also disclosed.

### FIELD OF THE INVENTION

The invention relates to recording systems, and more particularly, relates to a dual seed layer for recording media.

### BACKGROUND OF THE INVENTION

Recording media, such as magnetic and magneto-optical media, are well known. In constructing recording media, it is known to include a seed layer(s) upon which a recording layer is formed. The seed layer advantageously supports, for example, the adequate growth and nucleation of the recording layer. Thus, the seed layer can play an important role in creating a desired recording layer having suitable properties, such as high anisotropy, high coercivity and/or high remanent squareness, for high density recording.

Various seed layer materials and configurations have been proposed. However, with increasing emphasis on developing media with even higher recording densities, there is also increasing emphasis on developing improved recording layer and/or seed layer(s) configurations as well.

There is identified, therefore, a need for improved recording media that overcomes limitations, disadvantages, or shortcomings of known recording media. There is also identified a need for improved recording media capable of supporting higher recording densities than known recording media.

### SUMMARY OF THE INVENTION

The invention meets the identified need, as well as other needs, as will be more fully understood following a review of this specification and drawings.

In accordance with an aspect of the invention, a thin film structure comprises a first layer including at least one of Cu, Au, Ag, Al or copper alloys, a second layer adjacent the first layer and including a metal oxide, and a third layer adjacent the second layer and including a magnetic material. The third layer may be a recording layer. More particularly, the third layer may be a multilayer structure having means for magnetic data storage or magneto-optical data storage.

In accordance with yet another aspect of the invention, a recording medium comprises a recording layer and a dual layer seed layer. The dual layer seed layer comprises a first layer including at least one of Cu, Au, Ag, Al or copper alloys and a metal oxide layer formed between the recording layer and the first layer. The metal oxide layer may comprise indium-tin oxide (ITO) of varied indium oxide-tin oxide composition ratio, and other additives such as zinc in ITO, and may have a thickness in the range of about 0.5 m to about 5.0 nm. The first layer may have a thickness in the range of about 2 nm to about 200 nm.

In accordance with another aspect of the invention, a magnetic disc drive storage system comprises a perpendicular magnetic recording head and a perpendicular magnetic recording medium positioned adjacent the perpendicular magnetic recording head. The perpendicular magnetic recording medium comprises a hard magnetic recording layer, a soft magnetic underlayer and an intermediate layer between the hard magnetic layer and the soft magnetic underlayer. The intermediate layer comprises a first layer including at least one of Cu, Au, Ag, Al or copper alloys and a second layer including a metal oxide material such as, for example, ITO that is formed between the hard magnetic recording layer and the first layer.

### BRIEF DESCRIPTION OF THE DRAWINGS

FIG. 1 is a pictorial representation of a disc drive that may utilize a perpendicular recording medium in accordance with the invention.

FIG. 2 is a partially schematic side view of a perpendicular magnetic recording head and a perpendicular recording magnetic medium in accordance with the invention.

FIG. 3 is a schematic side view of a perpendicular recording magnetic medium in accordance with the invention.

FIG. 4 is a schematic side view of a recording medium in accordance with the invention.

FIG. 5 illustrates M-H loops for recording media, including the recording medium illustrated in FIG. 4, in accordance with the invention.

FIG. 6 illustrates a schematic side view of a prior art recording medium.

FIG. 7 illustrates an M-H loop for the recording medium illustrated in FIG. 6.

### DETAILED DESCRIPTION OF THE INVENTION

The invention provides a thin film structure. The invention is suitable for use with a disc drive storage system, and is particularly suitable for use with a perpendicular magnetic recording medium of a magnetic disc drive storage system. However, it will be appreciated that the invention may also have other applications, such as, for example magneto-optical recording, heat assisted magnetic recording, or other technologies that may utilize magnetic thin film structures.

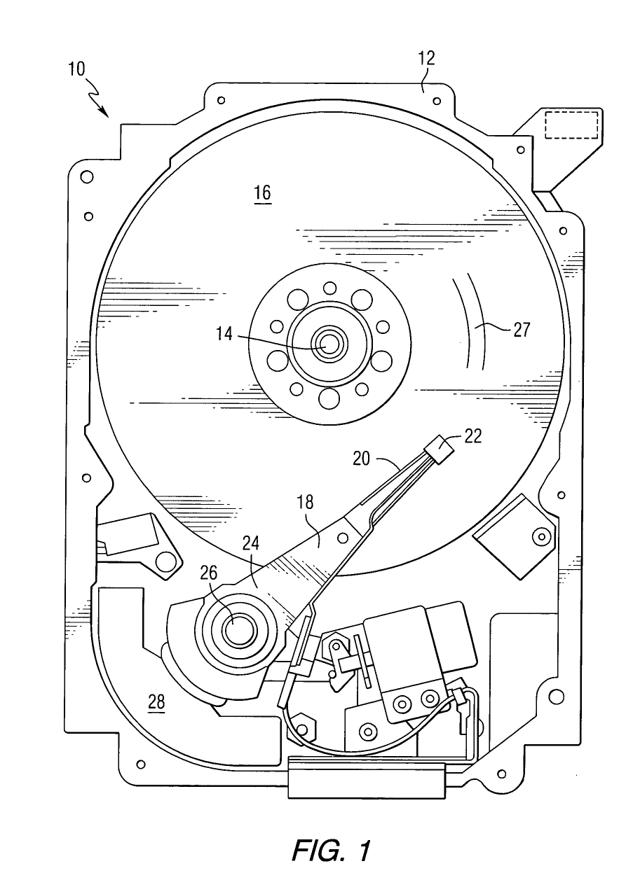

FIG. 1 is a pictorial representation of a disc drive 10 that can utilize a recording medium in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

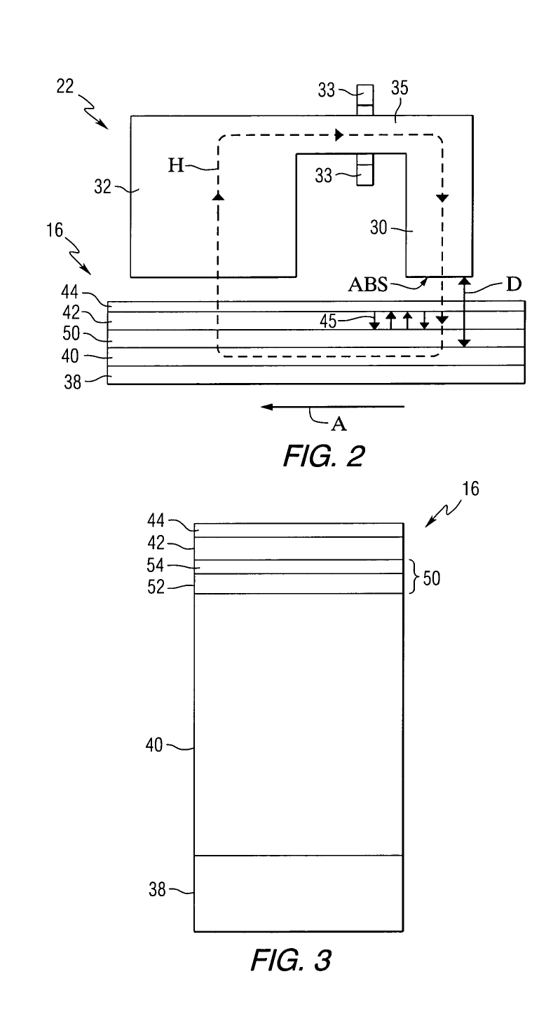

FIG. 2 is a partially schematic side view of a perpendicular magnetic recording head 22 and a perpendicular magnetic recording medium 16. The recording head 22 is well known in the art and includes a writer section comprising a trailing main pole 30 and a return or opposing pole 32. A magnetizing coil 33 surrounds a yoke 35, which connects the main pole 30 and return pole 32. The recording head 22 also may include a reader section (not shown), as is generally known in the art. The reader may include, for example, a conventional giant magneto-resistance (GMR) reader, magneto-resistance reader, inductive reader, magneto-optical reader, or the like as is also generally known in the art.

Still referring to FIG. 2, the perpendicular magnetic recording medium 16 is positioned under the recording head 22. The recording medium 16 travels in the direction of arrow A during recording. The recording medium 16 includes a substrate 38, which may be made of any suitable material such as ceramic glass, amorphous glass, or NiP plated AlMg. A soft magnetic layer (SUL) 40 is deposited on the substrate 38. The SUL 40 may be made of any suitable material such as FeCoB, CoZrNb or NiFeNb. The SUL 40 may have a thickness in the range of about 50 nm to about 500 nm. Although the recording medium 16 is shown having the SUL 40, it will be appreciated that the recording medium of the present invention may alternatively be constructed without a SUL. A hard magnetic recording layer 42, which in this embodiment is a perpendicular recording layer as illustrated by the perpendicular oriented magnetic domains 45, is deposited adjacent to or on an intermediate layer 50 that is formed adjacent to or on the SUL 40. Suitable materials for the hard magnetic recording layer 42 may include, for example, Co/Pd, Co/Pt, CoX/PdY, and CoX/PtY multilayer systems, wherein additive X may be Cr, B, Si, Au, Ag, and/or combinations of these elements, and Y may be B, Si, and/or combinations of these elements. It will be appreciated that the recording layer 42 may be constructed in accordance with the invention to provide, for example, magnetic data storage capabilities or magneto-optical data storage capabilities. A protective overcoat 44, such as a diamond-like carbon, and/or a lubricant layer (not shown) may be applied over the hard magnetic recording layer 42 as is generally known.

Referring to FIG. 3, an embodiment of the recording medium 16 is illustrated in more detail and, more particularly, an embodiment of the intermediate layer 50 having a dual layer seed layer is shown in more detail. Specifically, the intermediate layer 50 includes a seed layer 52 formed adjacent to or on the SUL 40. The seed layer 52 may comprise, for example, Cu, Au, Ag, Al, Cu alloys such as Cu—Zr, or similar materials or combinations thereof having properties such as, for example, materials having a suitably high surface energy. The seed layer 52 may have a thickness in the range of about 2 nm to about 200 nm. The intermediate layer 50 also includes an additional seed layer 54 formed between the seed layer 52 and the hard magnetic recording layer 42. The seed layer 54 may be formed of, for example, ITO of varied indium oxide-tin oxide composition ratio, or ITO-Zn. The seed layer 54 may have a thickness in the range of about 0.5 nm to about 5.0 nm. Thus, with the seed layer 52 and underlayer 54, the intermediate layer 50 may have a total thickness in the range of about 2.5 nm to about 205 nm. Advantageously, the intermediate layer 50 constructed in accordance with the invention allows for the formation of the recording medium 16 and, more specifically, for the formation of the recording layer 42 having suitable magnetic properties for perpendicular magnetic or magneto-optical recording.

In the design of a perpendicular magnetic recording system, it is important to maintain the spacing between an air-bearing surface (ABS) of the recording head 22 and the SUL 40 of the recording medium 16 as small as possible in order to obtain maximum writing field strength and high head field gradient. This spacing is illustrated by arrow D, as shown in FIG. 2. For a recording medium 16 constructed in accordance with the invention, the spacing D may be in the range of about 50 nm to about 500 nm.

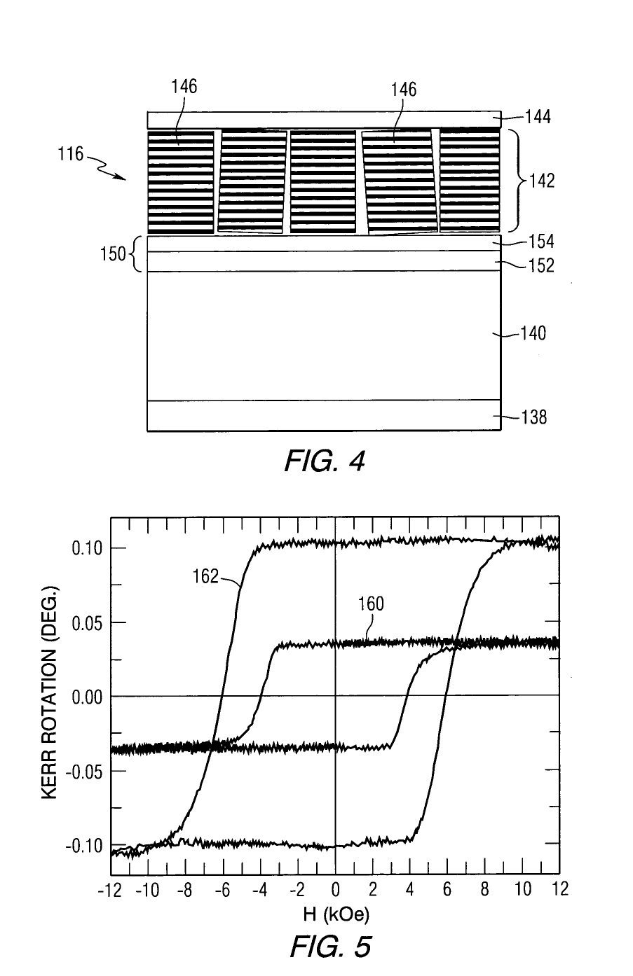

Referring to FIG. 4, there is illustrated another embodiment of a recording medium 116 constructed in accordance with the invention. Specifically, the recording medium 116 includes a substrate 138, a SUL 140, a seed layer 152, an additional seed layer 154, a recording layer 142, and a protective overcoat 144. The recording medium 116 may be formed with or without the SUL 140. The seed layer 152 and seed layer 154 together form an intermediate layer 150. As illustrated in FIG. 4, the recording layer 142 may comprise a multilayer structure formed by a plurality of individual multilayer components 146. However, it will be appreciated that a recording layer 142 having other than the described multilayer structure such as, for example, a granular structure may be used in association with the invention.

Still referring to FIG. 4, the structure of the recording medium 116 was constructed, for example, as follows: glass substrate 138/SUL 140 formed of FeCoB alloy having a thickness of 200 nm/seed layer 152 formed of Cu having a thickness of 2 nm/seed layer 154 formed of ITO, and specifically, indium oxide: tin oxide=70 at %:30 at % compositions having a thickness of 0.7 nm/recording layer 142 formed of Pd—Si 4 at % 1 nm and [Co having a thickness of 0.15 nm/Pd—Si 4 at % having a thickness of 1 nm]×13/protective overcoat 144 formed of CHN having a thickness of 5 nm.

The particular structure for forming the recording medium 116 shown in FIG. 4 was prepared using a commercial media deposition system, such as an Unaxis® Circulus M12. The estimated growth temperature for forming the described structure was about 165° C. The film growth time for the described structure was about 20 seconds. It was determined that no sputter gas pressure limitation is needed for forming the seed layer 154 formed of ITO in the range of 2.5 mTorr to 30 mTorr. Advantageously, this particular structure is formed using an industrial media manufacturing system capable of obtaining high throughput making the structure suitable for commercial production.

The described layer thicknesses such as 0.7 nm ITO for seed layer 154 and 0.15 nm Co for recording layer 142 are approximations based on the sputtering rate calculation. For example, the atomic size of Co is known as about 0.25 nm to about 0.3 nm. The Co layer thickness in the multilayer structure is much less than its atomic size. Therefore, the Co layers are expected to be in the “island” growth mode, in which a mono-layer or a few atomic layers of Co atoms agglomerate into islands partially covering the Pd—Si layers. The Co layer thickness of 0.15 nm should be considered as an averaged value of Co island heights. This discrete Co layer formation and the addition of non-magnetic Si in the polarized Pd layer are considered as the mechanism of the fine magnetic cluster formation in the multilayer.

Referring to FIG. 5, there is illustrated an M-H loop 160 for the recording medium 116 constructed with the SUL 140, and an M-H loop 162 for the same recording medium constructed without the SUL 140. Advantageously, both loops 160, 162 are shown as “sheared” indicating the formation of magnetically isolated fine clusters in the multilayer recording layer 142. The schematic representation of the recording medium 116 is intended to emphasize the clustered structure in this multilayer structure. The magnetic switching behavior in the recording medium is well described by using micromagnetic models, in which the medium consists of a 2-dimensional ensemble of very fine clusters of switching units. In the model, the factors such as the average size of the clusters, the degree of cluster size distribution, the average value of magnetic anisotropy per cluster and its distribution, ferromagnetic coupling and magneto-static coupling between the clusters contribute to the switching of the medium. The “shear” in the M-H loop indicates that the small switching units in the film actually switches in different magnetic fields.

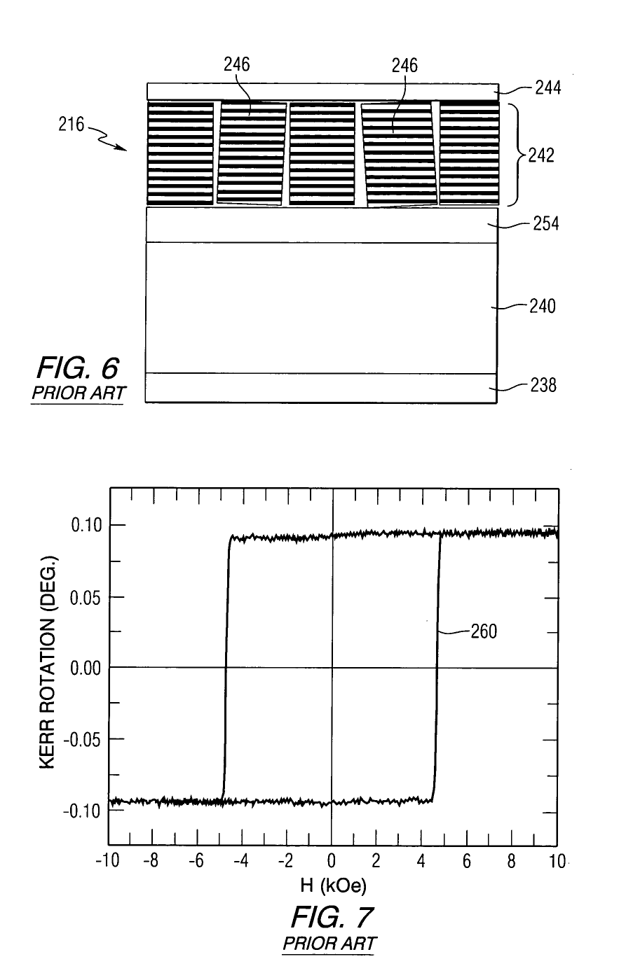

In contrast to the recording medium 116 illustrated in FIG. 4 that results in sheared M-H loops as illustrated in FIG. 5, an additional recording medium 216 (as illustrated in FIG. 6) was constructed without the seed layer 152 which resulted in an M-H loop 260 (as illustrated in FIG. 7) having a “non-sheared” configuration. The non-sheared M-H loop 260 is not desirable for forming a recording medium, as will be discussed herein. The recording layer 242 may be constructed to have multilayer components 246. The specific structure of the recording medium 216 is as follows: glass substrate 238/SUL 240 formed of FeCoB alloy having a total thickness of 200 nm/seed layer 254 formed of ITO (70-30 at % composition) having a thickness of 2 nm/Pd with a thickness of 2 nm/recording layer 242 formed of Pd—Si with a 2 nm thickness and [Co 0.15 nm/Pd—Si 1.2 nm]×13/protective overcoat 244 formed of CHN having a thickness of 5 nm. The estimated growth temperature was about 180° C., the sputter pressure for the seed layer 254 was about 3 mT, and the pressure for growing the multilayer structure 242 was about 20 mT of Kr gas.

As illustrated in FIG. 7, the M-H loop 260 for the recording medium 216 has a non-sheared or generally square configuration. In this case, the recording layer 242 is in the magnetically coupled state, as the result of absence of the Cu seed layer. The “square” M-H loop 260 indicates that the entire recording layer 242 under the magnetic field switches all at once at the coercive field. In the digital magnetic recording application, the smallest obtainable transition length from “0” to “1” (or “1” to “0”) depends on the size of the switching unit in the recording medium. Namely, a smaller switching unit provides possibly smaller transition length, and higher linear recording density. This same explanation also applies to the cross track direction.

A reason for the differing results for recording media 116 and 216, as described above, is the surface energy (this energy may also be referred to as the surface tension) difference between Cu and ITO when forming medium 116. Some fcc metals such as, for example, Cu, Au, and Ag are known for large surface energies, whereas oxides and other ceramics exhibit significantly lower surface energy. The high surface energy makes Cu a very suitable non-magnetic spacer for GMR and spin-valve reader element for a magnetic recording head. Therefore, any combination between high and low surface energy materials becomes a candidate for this usage.

In order to compare the properties, such as lattice parameters, crystalinity or surface energy in ITO films, the samples shown in FIGS. 4 and 6 were prepared with two different indium oxide/tin oxide composition ratios. The M-H loops shown in FIGS. 5 and 7 are of indium oxide: tin oxide=70 at %:30 at %. The other prepared samples include indium oxide:tin oxide=86.5 at %: 13.5 at %=90 wt %: 10 wt %, and the same results was obtained for this pair with the 70 at %:30 at % ITO samples, except the exact slope value in the sheared M-H loops. Both ITO materials gave amorphous like structures. However, the 70 at %:30 at % ITO may contain some nano-crystallites, whereas the 86.5 at %: 13.5 at % ITO seems to be amorphous in the selected area electron diffraction pattern under a transmission electron microscope observation. This result indicates that the crystalinity in ITO is not the main cause for the “sheared” M-H loop generation, although it may play a role in the control of exact slope value.

Whereas particular embodiments of the invention have been described herein for the purpose of illustrating the invention and not for purpose of limiting the same, it will be appreciated by those of ordinary skill in the art that numerous variations of the details, materials, and arrangements of parts may be made within the principle and scope of the invention without departing from the invention as described herein and in the appended claims.

1. A thin film structure, comprising:
a first layer including at least one of Cu, Au, Ag, Al or copper alloys;
a second layer adjacent said first layer, said second layer including a metal oxide; and
a third layer adjacent said second layer, said third layer including a magnetic material.

2. The thin film structure of claim 1, wherein said third layer is a recording layer comprising Co/Pd, Co/Pt, CoX/PdY, or CoX/PtY multilayer structures, wherein X is Cr, B, Si, Au, Ag or combinations thereof and Y is B, Si, or combinations thereof.

3. The thin film structure of claim 1, wherein said third layer is a multi-layer structure having means for magnetic data storage or magneto-optical data storage.

4. The thin film structure of claim 1, wherein said third layer includes means for perpendicularly recording data.

5. The thin film structure of claim 1, further comprising a soft magnetic layer, said first layer formed adjacent said soft magnetic layer.

6. The thin film structure of claim 1, wherein said first layer has a thickness in the range of about 2 nm to about 200 nm.

7. The thin film structure of claim 1, wherein said second layer comprises ITO or ITO-Zn.

8. The thin film structure of claim 1, wherein said second layer has a thickness in the range of about 0.5 nm to about 5.0 mm.

9. A recording medium, comprising:
a recording layer; and
a dual layer seed layer, comprising:
a first layer including at least one of Cu, Au, Ag, Al or copper alloys; and
a second layer formed between said recording layer and said first layer, said second layer comprising a metal oxide.

10. The recording medium of claim 9, further comprising a soft magnetic underlayer, said dual layer seed layer formed on the soft magnetic underlayer.

11. The recording medium of claim 9, wherein said second layer comprises ITO or ITO-Zn.

12. The recording medium of claim 9, wherein said first layer has a thickness in the range of about 2 nm to about 200 nm.

13. The recording medium of claim 9, wherein said second layer has a thickness in the range of about 0.5 nm to about 5.0 nm.

14. The recording medium of claim 9, wherein said recording layer comprises Co/Pd, Co/Pt, CoX/PdY, or CoX/PtY multilayer structures, wherein X is Cr, B, Si, Au, Ag or combinations thereof and Y is B, Si, or combinations thereof.

15. The recording medium of claim 9, wherein said recording layer is a multi-layer structure.

16. The recording medium of claim 9, wherein said recording layer is a perpendicular magnetic recording layer.

17. A magnetic disc drive storage system, comprising:
a perpendicular magnetic recording head; and
a perpendicular magnetic recording medium positioned adjacent said perpendicular magnetic recording head, said perpendicular magnetic recording medium comprising a hard magnetic recording layer, a soft magnetic underlayer and an intermediate layer between said hard magnetic recording layer and said soft magnetic underlayer, said intermediate layer comprising:
a first layer comprising Cu, Au, Ag, Al or copper alloys; and
a second layer comprising a metal oxide material that is formed between said hard magnetic recording layer and said first layer.

18. The system of claim 17, wherein said intermediate layer has a thickness in the range of about 2.5 nm to about 205 nm.

19. The system of claim 17, wherein said first layer has a thickness in the range of about 2 nm to about 200 nm.

20. The system of claim 17, wherein said perpendicular magnetic recording head has an air bearing surface, a distance between said air bearing surface and said soft magnetic underlayer being in the range of about 50 nm to about 500 nm.

21. The system of claim 17, wherein said second layer comprises ITO or ITO-Zn.
